(19) United States
(12) Patent Application Publication
(10) Pub. No.: US 2022/0129873 A1
(43) Pub. Date: Apr. 28, 2022

(54) METHOD AND SYSTEM FOR AN ELECTRONIC BILL PAYMENT PLATFORM

(71) Applicant: JPMorgan Chase Bank, N.A., New York, NY (US)

(72) Inventors: Razi ABBAS, Bangalore (IN); Tyrone LOBBAN, London (GB)

(73) Assignee: JPMorgan Chase Bank, N.A., New York, NY (US)

(21) Appl. No.: 17/449,514

(22) Filed: Sep. 30, 2021

Related U.S. Application Data
(60) Provisional application No. 63/122,612, filed on Dec. 8, 2020.

(30) Foreign Application Priority Data
Oct. 27, 2020 (IN) 202011046756

(51) Int. Cl. G06Q 20/14

(52) U.S. Cl. CPC G06Q 20/14

(57) ABSTRACT

A method for providing an electronic bill payment platform utilizing a distributed ledger is disclosed. The method includes receiving a request from a first user, the request including a payment request corresponding to a statement of charges; identifying, from a node, data corresponding to the request in the distributed ledger; initiating a first payment transaction based on the identified data and the request, the first payment transaction including a first debit from a user account to a holding account; initiating a second payment transaction based on the identified data and the request, the second payment transaction including a second debit from the holding account to a biller account; and updating, in the at least one node, the distributed ledger based on information corresponding to at least one from among the at least one request, the first payment transaction, and the second payment transaction.

### CROSS-REFERENCE TO RELATED APPLICATIONS

This application claims the benefit of Indian Provisional Patent Application No. 202011046756, filed Oct. 27, 2020, which is hereby incorporated by reference in its entirety. This application also claims the benefit of U.S. Provisional Patent Application Ser. No. 63/122,612, filed Dec. 8, 2020, which is hereby incorporated by reference in its entirety.

### BACKGROUND

### 1. Field of the Disclosure

This technology generally relates to methods and systems for electronic bill payment, and more particularly to methods and systems for providing an electronic bill payment platform for customers, billers, and payment providers utilizing a distributed ledger.

### 2. Background Information

Many entities such as, for example, utility services, education providers, financial entities, and even government agencies offer electronic payment options for users. The electronic payment options are traditionally provided separately by each of the many entities and may include onetime payment options as well as recurring payment options. Historically, offering electronic payment options separately by each of the many entities have resulted in varying degrees of success with respect to ease of use for the user, pooling of various types of funds, and operating efficiencies.

One drawback of conventionally offering separate electronic payment options is that in many instances, there is no single platform for a user to view bills and to make payments. As a result, the user must navigate numerous electronic payment platforms to view and pay bills from different entities. Additionally, the electronic payment platforms are generally incompatible with one another and must rely on supporting channels, which results in complex connection dependencies. The complex connection dependencies may result in limited payment features such as, for example, pooling funds from various user assets as well as increased operating costs associated with implementing an electronic payment platform for each of the many entities.

Therefore, there is a need for a unified electronic bill payment platform for customers, billers, and payment providers that resolves the complex dependencies by utilizing a distributed ledger such as, for example, a blockchain to facilitate transactions and maintain transaction records.

### SUMMARY

The present disclosure, through one or more of its various aspects, embodiments, and/or specific features or sub-components, provides, inter alia, various systems, servers, devices, methods, media, programs, and platforms for providing an electronic bill payment platform for customers, billers, and payment providers utilizing a distributed ledger.

According to an aspect of the present disclosure, a method for providing an offer to a potential recipient is disclosed. The method may be implemented by at least one processor. The method may include receiving, via a graphical user interface, at least one request from a first user, the at least one request may include a payment request corresponding to a statement of charges; identifying, from at least one node, data corresponding to the at least one request in the distributed ledger, the data may include a user account identifier and a biller account identifier; initiating a first payment transaction based on the identified data and the at least one request, the first payment transaction may include a first debit from a user account to a holding account; determining whether the first payment transaction is completed; initiating, according to a result of the determining, a second payment transaction based on the identified data and the at least one request, the second payment transaction may include a second debit from the holding account to a biller account; and updating, in the at least one node, the distributed ledger based on information corresponding to at least one from among the at least one request, the first payment transaction, and the second payment transaction.

In accordance with an exemplary embodiment, the distributed ledger may include at least one blockchain, the blockchain may include a plurality of blocks corresponding to a growing list of records.

In accordance with an exemplary embodiment, the method may further include receiving, via the graphical user interface, at least one input from a second user, the at least one input may include an account registration request and metadata corresponding to at least one biller; transmitting, via a network interface, the at least one input to the at least one biller; receiving authorization from the at least one biller; associating the second user with the metadata; and updating, in the at least one node, the distributed ledger based on the association.

In accordance with an exemplary embodiment, the at least one biller may include at least one from among a utility entity, an education entity, a government entity, a financial services entity, and a merchant entity.

In accordance with an exemplary embodiment, the method may further include receiving, via an application programing interface, a plurality of billing requests from at least one biller, each of the plurality of billing requests may include a new statement of charges; extracting the user account identifier for each of the plurality of billing requests; associating each of the plurality of billing requests with a corresponding user based on the extracted user account identifier; and updating, in the at least one node, the distributed ledger based on the association.

In accordance with an exemplary embodiment, the method may further include generating at least one settlement statement by using the distributed ledger, the at least one settlement statement may include information that relates to the plurality of billing requests; generating at least one report by using the distributed ledger, the at least one report may include information that relates to at least one billing request with an outstanding balance; and transmitting, via the application programming interface, the at least one settlement statement and the at least one report to the at least one biller based on a predetermined preference.

In accordance with an exemplary embodiment, the statement of charges may include at least one from among a first amount of money owed for goods supplied and a second amount of money owed for services rendered.

In accordance with an exemplary embodiment, to update the distributed ledger, the method may further include generating a new ledger entry; determining, via each of the at least one node, whether the new ledger entry accurately represent the requested update by using a consensus algorithm; and updating each of the at least one node with the new ledger entry based on a result of the determining.

In accordance with an exemplary embodiment, the method may further include receiving, via the graphical user interface, at least one display request from the first user, the at least one display request may relate to an instruction to display at least one outstanding statement of charges; extracting the user account identifier from the at least one display request; identifying the at least one outstanding statement of charges from the distributed ledger by using the extracted user account identifier; and compiling, via the at least one node, information that relates to the identified at least one outstanding statement of charges from the distributed ledger.

In accordance with an exemplary embodiment, the method may further include generating at least one selectable graphical element, the selectable graphical element may include the compiled information; and displaying, via the graphical user interface, the at least one selectable graphical element in response to the at least one display request.

According to an aspect of the present disclosure, a computing device configured to implement an execution of a method for providing an electronic bill payment platform utilizing a distributed ledger is disclosed. The computing device comprising a processor; a memory; and a communication interface coupled to each of the processor and the memory, wherein the processor may be configured to receive, via a graphical user interface, at least one request from a first user, the at least one request may include a payment request corresponding to a statement of charges; identify, from at least one node, data corresponding to the at least one request in the distributed ledger, the data may include a user account identifier and a biller account identifier; initiate a first payment transaction based on the identified data and the at least one request, the first payment transaction may include a first debit from a user account to a holding account; determine whether the first payment transaction is completed; initiate, according to a result of the determining, a second payment transaction based on the identified data and the at least one request, the second payment transaction may include a second debit from the holding account to a biller account; and update, in the at least one node, the distributed ledger based on information corresponding to at least one from among the at least one request, the first payment transaction, and the second payment transaction.

In accordance with an exemplary embodiment, the distributed ledger may include at least one blockchain on a peer-to-peer network, the at least one blockchain may include a plurality of blocks corresponding to a growing list of records.

In accordance with an exemplary embodiment, the processor may be further configured to receive, via the graphical user interface, at least one input from a second user, the at least one input may include an account registration request and metadata corresponding to at least one biller; transmit, via a network interface, the at least one input to the at least one biller; receive authorization from the at least one biller; associate the second user with the metadata; and update, in the at least one node, the distributed ledger based on the association.

In accordance with an exemplary embodiment, the at least one biller may include at least one from among a utility entity, an education entity, a government entity, a financial services entity, and a merchant entity.

In accordance with an exemplary embodiment, the processor may be further configured to receive, via an application programing interface, a plurality of billing requests from at least one biller, each of the plurality of billing requests may include a new statement of charges; extract the user account identifier from each of the plurality of billing requests; associate each of the plurality of billing requests with a corresponding user based on the extracted user account identifier; and update, in the at least one node, the distributed ledger based on the association.

In accordance with an exemplary embodiment, the processor may be further configured to generate at least one settlement statement by using the distributed ledger, the at least one settlement statement may include information that relates to the plurality of billing requests; generate at least one report by using the distributed ledger, the at least one report may include information that relates to at least one billing request with an outstanding balance; and transmit, via the application programming interface, the at least one settlement statement and the at least one report to the at least one biller based on a predetermined preference.

In accordance with an exemplary embodiment, the statement of charges may include at least one from among a first amount of money owed for goods supplied and a second amount of money owed for services rendered.

In accordance with an exemplary embodiment, to update the distributed ledger, the processor may be further configured to generate a new ledger entry; determine, via each of the at least one node, whether the new ledger entry accurately represent the requested update by using a consensus algorithm; and update each of the at least one node with the new ledger entry based on a result of the determining.

In accordance with an exemplary embodiment, the processor may be further configured to receive, via the graphical user interface, at least one display request from the first user, the at least one display request may relate to an instruction to display at least one outstanding statement of charges; extract the user account identifier from the at least one display request; identify the at least one outstanding statement of charges from the distributed ledger by using the extracted user account identifier; and compile, via the at least one node, information that relates to the identified at least one outstanding statement of charges from the distributed ledger.

In accordance with an exemplary embodiment, the processor may be further configured to generate at least one selectable graphical element, the selectable graphical element may include the compiled information; and display, via the graphical user interface, the at least one selectable graphical element in response to the at least one display request.

According to an aspect of the present disclosure, a non-transitory computer readable storage medium storing instructions for providing an electronic bill payment platform utilizing a distributed ledger is disclosed. The storage medium includes executable code which, when executed by a processor, may cause the processor to receive, via a graphical user interface, at least one request from a first user, the at least one request may include a payment request corresponding to a statement of charges; identify, from at least one node, data corresponding to the at least one request in the distributed ledger, the data may include a user account identifier and a biller account identifier; initiate a first payment transaction based on the identified data and the at least one request, the first payment transaction may include a first debit from a user account to a holding account; determine whether the first payment transaction is completed; initiate, according to a result of the determining, a second payment transaction based on the identified data and the at least one request, the second payment transaction may include a second debit from the holding account to a biller account; and update, in the at least one node, the distributed ledger based on information corresponding to at least one from among the at least one request, the first payment transaction, and the second payment transaction.

In accordance with an exemplary embodiment, when executed by the at least one processor, the executable code may further cause the processor to receive, via the graphical user interface, at least one display request from the first user, the at least one display request may relate to an instruction to display at least one outstanding statement of charges; extract the user account identifier from the at least one display request; identify the at least one outstanding statement of charges from the distributed ledger by using the extracted user account identifier; and compile, via the at least one node, information that relates to the identified at least one outstanding statement of charges from the distributed ledger.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing an electronic bill payment platform for customers, billers, and payment providers utilizing a distributed ledger.

FIG. 4 is a flowchart of an exemplary process for implementing a method for providing an electronic bill payment platform for customers, billers, and payment providers utilizing a distributed ledger.

FIG. 5 is a diagram that illustrates a system that is usable for implementing a method for providing an electronic bill payment platform for customers, billers, and payment providers utilizing a distributed ledger, according to an exemplary embodiment.

FIG. 6 is a diagram that illustrates a user registration process and a bill addition process that is usable for implementing a method for providing an electronic bill payment platform for customers, billers, and payment providers utilizing a distributed ledger, according to an exemplary embodiment.

FIG. 7 is a diagram that illustrates a payment process that is usable for implementing a method for providing an electronic bill payment platform for customers, billers, and payment providers utilizing a distributed ledger, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

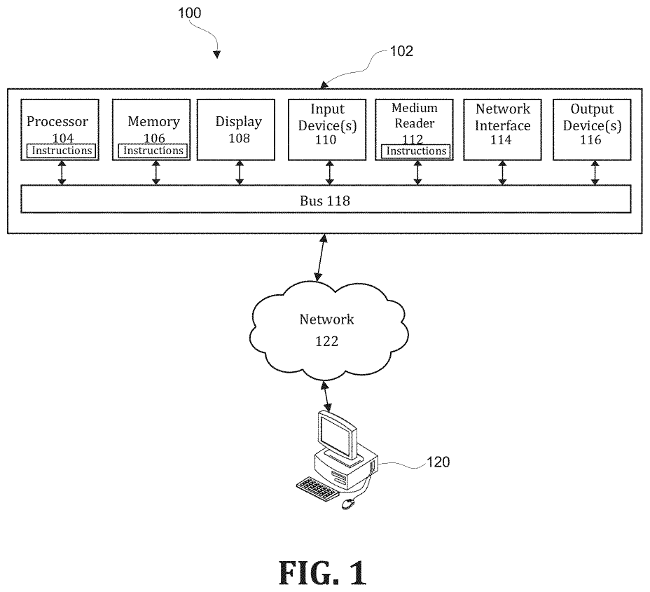

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing an electronic bill payment platform for customers, billers, and payment providers utilizing a distributed ledger.

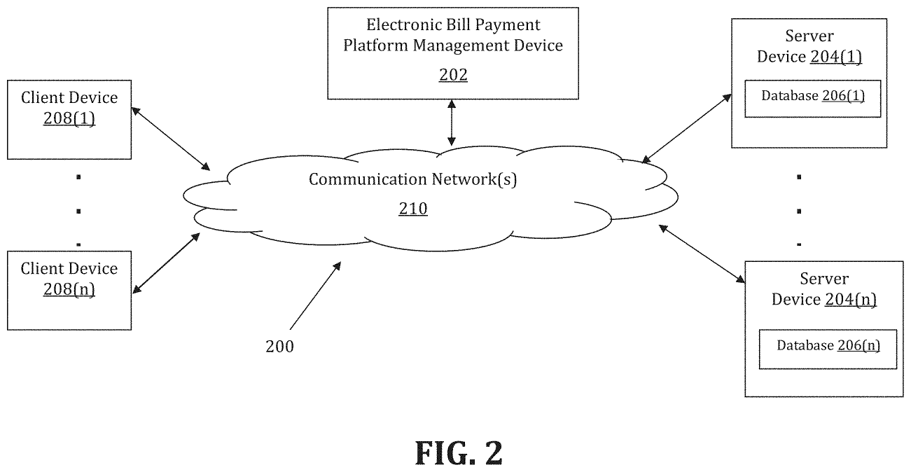

Referring to FIG. 2, a schematic of an exemplary network environment 200 for implementing a method for providing an electronic bill payment platform for customers, billers, and payment providers utilizing a distributed ledger is illustrated. In an exemplary embodiment, the method is executable on any networked computer platform, such as, for example, a personal computer (PC).

The method for providing an electronic bill payment platform for customers, billers, and payment providers utilizing a distributed ledger may be implemented by an Electronic Bill Payment Platform Management (EBPPM) device 202. The EBPPM device 202 may be the same or similar to the computer system 102 as described with respect to FIG. 1. The EBPPM device 202 may store one or more applications that can include executable instructions that, when executed by the EBPPM device 202, cause the EBPPM device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the EBPPM device 202 itself, may be located in virtual server(s) running in a cloud-based computing environment rather than being tied to one or more specific physical network computing devices. Also, the application(s) may be running in one or more virtual machines (VMs) executing on the EBPPM device 202. Additionally, in one or more embodiments of this technology, virtual machine(s) running on the EBPPM device 202 may be managed or supervised by a hypervisor.

In the network environment 200 of FIG. 2, the EBPPM device 202 is coupled to a plurality of server devices 204(1)-204(n) that hosts a plurality of databases 206(1)-206(n), and also to a plurality of client devices 208(1)-208(n) via communication network(s) 210. A communication interface of the EBPPM device 202, such as the network interface 114 of the computer system 102 of FIG. 1, operatively couples and communicates between the EBPPM device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the EBPPM device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and EBPPM devices that efficiently implement a method for providing an electronic bill payment platform for customers, billers, and payment providers utilizing a distributed ledger.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The EBPPM device 202 may be a standalone device or integrated with one or more other devices or apparatuses, such as one or more of the server devices 204(1)-204(n), for example. In one particular example, the EBPPM device 202 may include or be hosted by one of the server devices 204(1)-204(n), and other arrangements are also possible. Moreover, one or more of the devices of the EBPPM device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the EBPPM device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to distributed ledgers, blockchains, user account identifiers, biller account identifiers, and payment provider identifiers.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the EBPPM device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the EBPPM device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the EBPPM device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the EBPPM device 202, the server devices 204(1)-204(n), or the client devices 208(1)-208(n), for example, may be configured to operate as virtual instances on the same physical machine. In other words, one or more of the EBPPM device 202, the server devices 204(1)-204(n), or the client devices 208(1)-208(n) may operate on the same physical device rather than as separate devices communicating through communication network(s) 210. Additionally, there may be more or fewer EBPPM devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

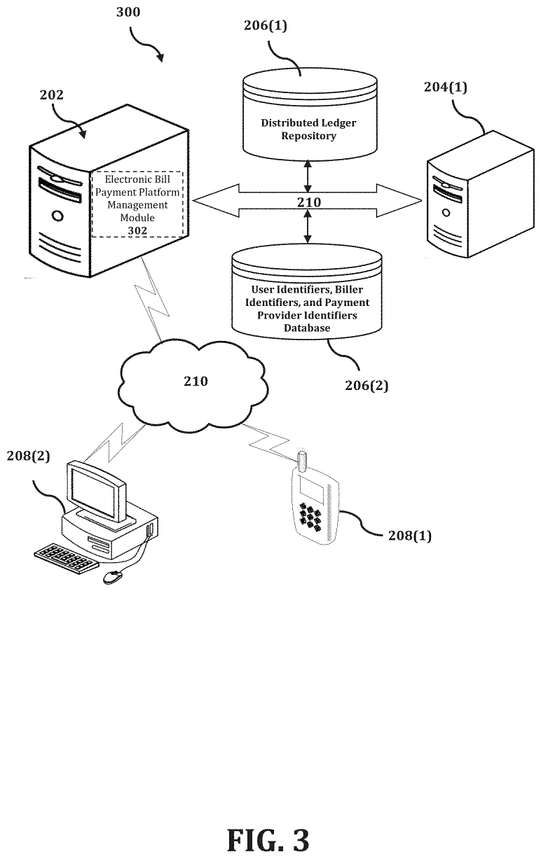

The EBPPM device 202 is described and shown in FIG. 3 as including an electronic bill payment platform management module 302, although it may include other rules, policies, modules, databases, or applications, for example. As will be described below, the electronic bill payment platform management module 302 is configured to implement a method for providing an electronic bill payment platform for customers, billers, and payment providers utilizing a distributed ledger.

An exemplary process 300 for implementing a mechanism for providing an electronic bill payment platform for customers, billers, and payment providers utilizing a distributed ledger by utilizing the network environment of FIG. 2 is shown as being executed in FIG. 3. Specifically, a first client device 208(1) and a second client device 208(2) are illustrated as being in communication with EBPPM device 202. In this regard, the first client device 208(1) and the second client device 208(2) may be “clients” of the EBPPM device 202 and are described herein as such. Nevertheless, it is to be known and understood that the first client device 208(1) and/or the second client device 208(2) need not necessarily be “clients” of the EBPPM device 202, or any entity described in association therewith herein. Any additional or alternative relationship may exist between either or both of the first client device 208(1) and the second client device 208(2) and the EBPPM device 202, or no relationship may exist.

Further, EBPPM device 202 is illustrated as being able to access a distributed ledger repository 206(1) and a user identifiers, biller identifiers, and payment provider identifiers database 206(2). The electronic bill payment platform management module 302 may be configured to access these databases for implementing a method for providing an electronic bill payment platform for customers, billers, and payment providers utilizing a distributed ledger.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the EBPPM device 202 via broadband or cellular communication. Of course, these embodiments are merely exemplary and are not limiting or exhaustive.

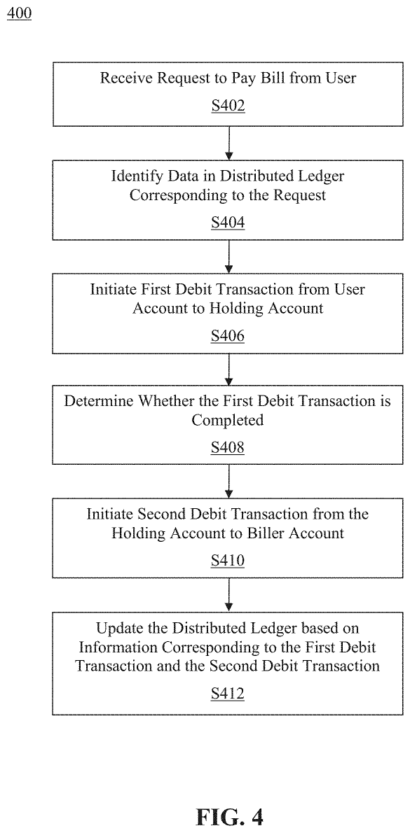

Upon being started, the electronic bill payment platform management module 302 executes a process for providing an electronic bill payment platform for customers, billers, and payment providers utilizing a distributed ledger. An exemplary process for providing an electronic bill payment platform for customers, billers, and payment providers utilizing a distributed ledger is generally indicated at flowchart 400 in FIG. 4.

In the process 400 of FIG. 4, at step S402, a request may be received from a first user via a graphical user interface. The request may include a payment request corresponding to a statement of charges such as, for example, a bill. In an exemplary embodiment, the first user may currently hold a registered account with the electronic bill payment platform. The registered account may include information corresponding to the first user such as, for example, a username, login credentials, and an asset account of the user. In another exemplary embodiment, the electronic bill payment platform may automatically generate a user account identifier for the first user. The user account identifier may be associated with the information corresponding to the first user. In another exemplary embodiment, the user account identifier may be encoded and stored as metadata together with the information corresponding to the first user.

In another exemplary embodiment, the electronic bill payment platform may display, via the graphical user interface, all outstanding bills currently associated with the first user. The outstanding bills may be presented in a list for selection by the first user. In another exemplary embodiment, selectable graphical elements may represent each of the outstanding bills in the graphical user interface. Selection of the graphical elements may cause the graphical user interface to automatically compile bill data corresponding to the selected graphical element. The compiled data may then be transmitted to the electronic bill payment platform for processing according to embodiments in the present application.

At step S404, data corresponding to the request may be identified in a distributed ledger from at least one node. The data may include a user account identifier and a biller account identifier. In an exemplary embodiment, the electronic bill payment platform may utilize a database management software such as, for example, AMAZON Relational Database Service (RDS) and MICROSOFT Structured Query Language (SQL) Server to identify the data from the at least one node. The database management software may be utilized to store, manipulate, and manage data according to a specified file structure in a database. In another exemplary embodiment, the number of nodes utilized by the electronic bill payment platform may depend on a predetermined factor such as, for example, data security, data accuracy, and operational costs. For example, gathering the data from five nodes and comparing the gathered data to detect inconsistencies may increase data accuracy over gathering the data from a single node.

In another exemplary embodiment, the distributed ledger may include databases that are spread across several nodes on a peer-to-peer network. Each node on the peer-to-peer network replicates and saves an identical copy of a ledger and updates itself independently without input from a central administrator. In another exemplary embodiment, when a ledger update is requested, each node may construct a new transaction in the ledger. Each node may then utilize a consensus algorithm to determine which of the newly generated transactions most accurately represent the requested ledger update. Based on a result of the determination, all the nodes in the peer-to-peer network may update their own ledgers with the agreed upon new transaction. As will be appreciated by a person of ordinary skill in the art, the communication between each of the nodes may be secured via cryptographic keys and electronic signatures.

In another exemplary embodiment, the distributed ledger may include at least one blockchain. The blockchain may include a plurality of blocks corresponding to a growing list of records. In another exemplary embodiment, each of the plurality of blocks on the blockchain may include digital pieces of information such as, for example, a date, a time, a dollar amount, and participant names that correspond to a transaction. Each of the plurality of blocks on the blockchain may also include identifying data which distinguishes a particular block from other blocks on the blockchain. In another exemplary embodiment, each block may utilize a unique code such as, for example, a hash as identifying data. The hashes may include cryptographic codes that are automatically generated by an algorithm.

In another exemplary embodiment, after a transaction has occurred, the transaction may be verified, and the details of the transaction may be confirmed. Then, information corresponding to the transaction may be stored in a block. In another exemplary embodiment, transaction data from a plurality of transactions may be packaged together in a single block. Once a block has been compiled, a hash unique to the block may be automatically generated and encoded within the block. In another exemplary embodiment, a hash value of a preceding block may also be encoded within the block. Finally, the compiled block may then be added to the blockchain. In another exemplary embodiment the blockchain may include a public blockchain and a private blockchain.

At step S406, a first payment transaction may be initiated based on the identified data and the request. The first payment transaction may include a first debit from a user account to a holding account. In an exemplary embodiment, smart contracts such as, for example, a computer program and a transaction protocol may be utilized to facilitate the debit transactions. The smart contract may automatically execute, control, and document legally relevant events and actions according to terms of a preexisting contract and/or agreement.

In another exemplary the holding account may be operated by the electronic bill payment platform and may be configured to accept user assets from various sources. The holding account may enable the first user to pool assets from unrelated sources. For example, the first user may choose to pay a $50 bill with $25 from bank A and $25 from bank B. Alternatively, the first user may choose to pay a $50 bill with $25 from investment vehicle A and $25 from bank B.

In another exemplary embodiment, the first payment transaction may include a plurality of user assets. The plurality of assets may include anything that can be owned and/or controlled to produce value. In another exemplary embodiment, the plurality of assets may include digital assets such as, for example, a digital document, an audible content, a video content, and a digital currency. The digital currency may exhibit properties similar to physical currencies, but do not have a physical form of banknotes and coins. The digital currencies may include a balance and/or a record that is stored in a distributed database on a network. Digital currencies may include virtual currencies, central bank digital currencies, e-Cash, and cryptocurrencies such as, for example, BITCOIN.

At step S408, a determination may be made as to whether the first payment transaction is completed. In an exemplary embodiment, the first payment transaction may be completed when the total amount due for the selected bill is equivalent to a balance in the holding account. The balance in the holding account may be associated with the first payment transaction by using a transaction identifier. As will be appreciated by a person of ordinary skill in the art, the electronic bill payment platform may utilize any verification technique to confirm that the total amount due is equal to the amount in the holding account.

Then, at step S410, according to a result of the determination, a second payment transaction may be initiated based on the identified data and the at least one request. The second payment transaction may include a second debit from the holding account to a biller account. In an exemplary embodiment, a notification may be displayed on the graphical user interface after the second payment transaction has been completed. The notification may include information relating to at least one from among the request, the first payment transaction, and the second payment transaction. In another exemplary embodiment, the notification may also include a visual alert as well as an audible alert.

At step S412, the distributed ledger in at least one node may be updated based on information corresponding to at least one from among the request, the first payment transaction, and the second payment transaction. In an exemplary embodiment, when a ledger update is requested, each node may construct a new transaction in the ledger. Each node may then utilize a consensus algorithm to determine which of the newly generated transactions most accurately represent the requested ledger update. Based on a result of the determination, all the nodes in the peer-to-peer network may update their own ledgers with the agreed upon new transaction. As will be appreciated by a person of ordinary skill in the art, the distributed ledger may be updated consistent with the technology implemented to maintain the ledger according to embodiments in the present application.

In another exemplary embodiment, a second user may register for an account with the electronic bill payment platform. An input from the second user may be received via the graphical user interface. The input may include an account registration request and metadata corresponding to a biller. Then, the input may be transmitted to the biller via a network interface. In response, an authorization to associate the second user with the biller's metadata may be received from the biller. An association may then be made between the second user and the metadata. Finally, the distributed ledger in at least one node may be updated based on the association.

In another exemplary embodiment, the biller may include at least one from among a utility entity, an education entity, a government entity, a financial services entity, and a merchant entity. The biller may be associated with a unique biller identifier that may be used as a global identifier for the biller.

In another exemplary embodiment, the biller may utilize the electronic bill payment platform to provide bills to corresponding users. A plurality of billing requests from the biller may be received via an application programming interface (API) such that each of the plurality of billing requests may include a new statement of charges. A user account identifier from each of the plurality of billing requests may be extracted and analyzed. Each of the plurality of billing requests may then be associated with a corresponding user based on the extracted user account identifier. Finally, the distributed ledger in at least one node may be updated based on the association.

In another exemplary embodiment, the new statement of charges may include at least one from among a first amount of money owed for goods supplied and a second amount of money owed for services rendered. The new statement of charges may include predefined metadata such as, for example, an account number, an amount, a comment, a bill date, and a previous payment date.

In another exemplary embodiment, the electronic bill payment platform may provide settlement statements to the billers. The settlement statements may include information corresponding to the plurality of billing requests. In another exemplary embodiment, the settlement statements may include a report outlining outstanding bills where a payment has not been applied. Reconciliation by the biller may not be necessary as payments by users are immediately settled and available for viewing in the settlement statements.

In another exemplary embodiment, the electronic bill payment platform may be accessible for users and billers via an application programming interface (API). The API may be utilized by third-party applications as well as internal applications to enable access for the users and the billers.

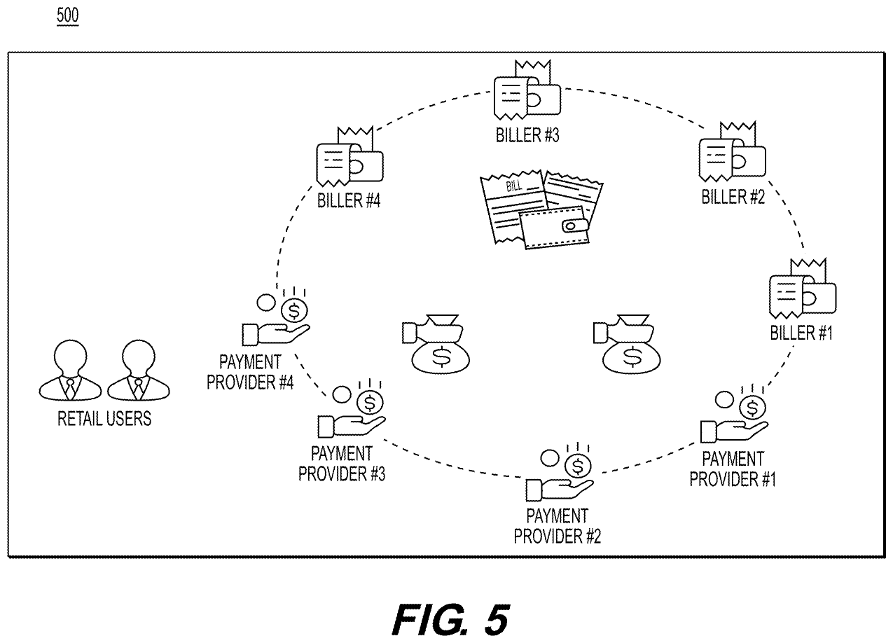

FIG. 5 is a diagram 500 that illustrates a system that is usable for implementing a method for providing an electronic bill payment platform for customers, billers, and payment providers utilizing a distributed ledger, according to an exemplary embodiment. As illustrated in FIG. 5, the electronic bill payment platform includes retail users, billers, and payment providers. The electronic bill payment platform may operate as a single platform where the retail users, billers, and payment providers may settle transactions.

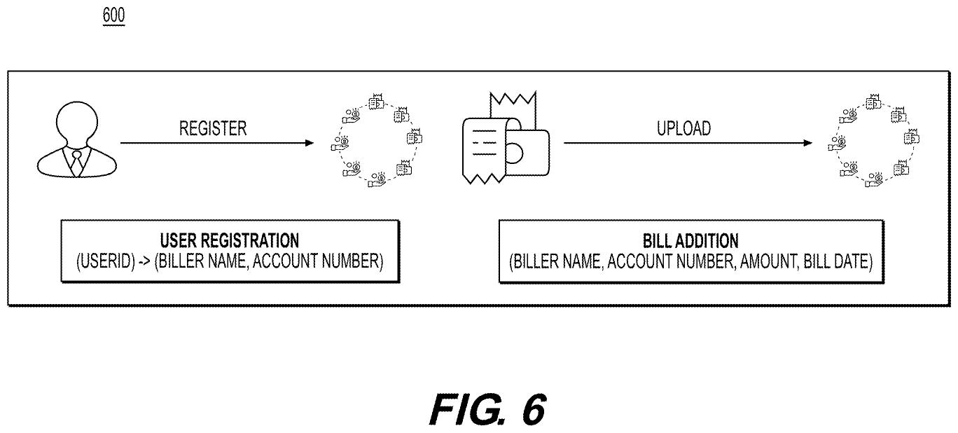

FIG. 6 is a diagram 600 that illustrates a user registration process and a bill addition process that is usable for implementing a method for providing an electronic bill payment platform for customers, billers, and payment providers utilizing a distributed ledger, according to an exemplary embodiment.

As illustrated in FIG. 6, the electronic bill payment platform enables a user to register for a new association with a biller as well as for a biller to add bills for the user. In the user registration process, the user may provide information such as, for example, a biller name and a user account number. The system may then associate a user account identifier with the provided information. After the user has been associated with the biller, the biller may add bills corresponding to the user. The bills may include metadata such as, for example, a biller name, an account number, an amount, and a bill date.

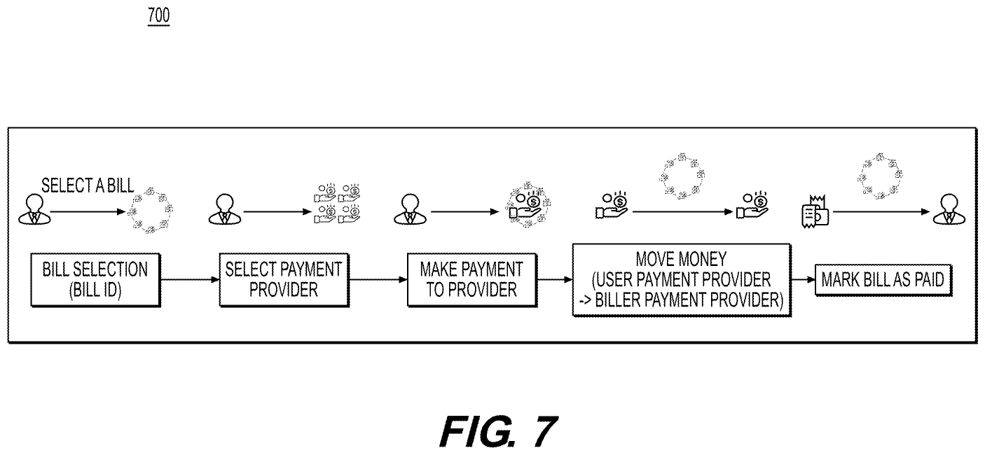

FIG. 7 is a diagram 700 that illustrates a payment process that is usable for implementing a method for providing an electronic bill payment platform for customers, billers, and payment providers utilizing a distributed ledger, according to an exemplary embodiment. As illustrated in FIG. 7, a user may select a bill in the bill selection step by utilizing a bill identifier. The user may then select a payment provider for the selected bill and make a payment to the payment provider. Money paid to the payment provider may then be transferred to the account of the biller. Once the electronic bill payment platform has determined that payment has been successfully completed, the electronic bill payment platform marks the bill as paid and proceeds to update the distributed ledger consistent with embodiments in the present application.

Accordingly, with this technology, an optimized process for providing an electronic bill payment platform for customers, billers, and payment providers utilizing a distributed ledger is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for providing an electronic bill payment platform utilizing a distributed ledger, the method being implemented by at least one processor, the method comprising:
receiving, by the at least one processor via a graphical user interface, at least one request from a first user, the at least one request including a payment request corresponding to a statement of charges;
identifying, by the at least one processor from at least one node, data corresponding to the at least one request in the distributed ledger, the data including a user account identifier and a biller account identifier;
initiating, by the at least one processor, a first payment transaction based on the identified data and the at least one request, the first payment transaction including a first debit from a user account to a holding account;
determining, by the at least one processor, whether the first payment transaction is completed;
initiating, by the at least one processor according to a result of the determining, a second payment transaction based on the identified data and the at least one request, the second payment transaction including a second debit from the holding account to a biller account; and
updating, by the at least one processor in the at least one node, the distributed ledger based on information corresponding to at least one from among the at least one request, the first payment transaction, and the second payment transaction.

2. The method of claim 1, wherein the distributed ledger includes at least one blockchain on a peer-to-peer network, the at least one blockchain including a plurality of blocks corresponding to a growing list of records.

3. The method of claim 1, further comprising:
receiving, by the at least one processor via the graphical user interface, at least one input from a second user, the at least one input including an account registration request and metadata corresponding to at least one biller;
transmitting, by the at least one processor via a network interface, the at least one input to the at least one biller;
receiving, by the at least one processor, authorization from the at least one biller;
associating, by the at least one processor, the second user with the metadata; and
updating, by the at least one processor in the at least one node, the distributed ledger based on the association.

4. The method of claim 3, wherein the at least one biller includes at least one from among a utility entity, an education entity, a government entity, a financial services entity, and a merchant entity.

5. The method of claim 1, further comprising:
receiving, by the at least one processor via an application programing interface, a plurality of billing requests from at least one biller, each of the plurality of billing requests including a new statement of charges;
extracting, by the at least one processor, the user account identifier from each of the plurality of billing requests;
associating, by the at least one processor, each of the plurality of billing requests with a corresponding user based on the extracted user account identifier; and
updating, by the at least one processor in the at least one node, the distributed ledger based on the association.

6. The method of claim 5, further comprising:
generating, by the at least one processor, at least one settlement statement by using the distributed ledger, the at least one settlement statement including information that relates to the plurality of billing requests;
generating, by the at least one processor, at least one report by using the distributed ledger, the at least one report including information that relates to at least one billing request with an outstanding balance; and
transmitting, by the at least one processor via the application programming interface, the at least one settlement statement and the at least one report to the at least one biller based on a predetermined preference.

7. The method of claim 1, wherein the statement of charges includes at least one from among a first amount of money owed for goods supplied and a second amount of money owed for services rendered.

8. The method of claim 1, wherein updating the distributed ledger further comprises:
generating, by the at least one processor, a new ledger entry;
determining, by the at least one processor via each of the at least one node, whether the new ledger entry accurately represent the requested update by using a consensus algorithm; and
updating, by the at least one processor, each of the at least one node with the new ledger entry based on a result of the determining.

9. The method of claim 1, further comprising:
receiving, by the at least one processor via the graphical user interface, at least one display request from the first user, the at least one display request relating to an instruction to display at least one outstanding statement of charges;
extracting, by the at least one processor, the user account identifier from the at least one display request;
identifying, by the at least one processor, the at least one outstanding statement of charges from the distributed ledger by using the extracted user account identifier; and
compiling, by the at least one processor via the at least one node, information that relates to the identified at least one outstanding statement of charges from the distributed ledger.

10. The method of claim 9, further comprising:
generating, by the at least one processor, at least one selectable graphical element, the selectable graphical element including the compiled information; and
displaying, by the at least one processor via the graphical user interface, the at least one selectable graphical element in response to the at least one display request.

11. A computing device configured to implement an execution of a method for providing an electronic bill payment platform utilizing a distributed ledger, the computing device comprising:
a processor;
a memory; and
a communication interface coupled to each of the processor and the memory, wherein the processor is configured to:
receive, via a graphical user interface, at least one request from a first user, the at least one request including a payment request corresponding to a statement of charges;
identify, from at least one node, data corresponding to the at least one request in the distributed ledger, the data including a user account identifier and a biller account identifier;
initiate a first payment transaction based on the identified data and the at least one request, the first payment transaction including a first debit from a user account to a holding account;
determine whether the first payment transaction is completed;
initiate, according to a result of the determining, a second payment transaction based on the identified data and the at least one request, the second payment transaction including a second debit from the holding account to a biller account; and
update, in the at least one node, the distributed ledger based on information corresponding to at least one from among the at least one request, the first payment transaction, and the second payment transaction.

12. The computing device of claim 11, wherein the distributed ledger includes at least one blockchain on a peer-to-peer network, the at least one blockchain including a plurality of blocks corresponding to a growing list of records.

13. The computing device of claim 11, wherein the processor is further configured to:
receive, via the graphical user interface, at least one input from a second user, the at least one input including an account registration request and metadata corresponding to at least one biller;
transmit, via a network interface, the at least one input to the at least one biller;
receive authorization from the at least one biller;
associate the second user with the metadata; and
update, in the at least one node, the distributed ledger based on the association.

14. The computing device of claim 13, wherein the at least one biller includes at least one from among a utility entity, an education entity, a government entity, a financial services entity, and a merchant entity.

15. The computing device of claim 11, wherein the processor is further configured to:
receive, via an application programing interface, a plurality of billing requests from at least one biller, each of the plurality of billing requests including a new statement of charges;
extract the user account identifier from each of the plurality of billing requests;
associate each of the plurality of billing requests with a corresponding user based on the extracted user account identifier; and
update, in the at least one node, the distributed ledger based on the association.

16. The computing device of claim 15, wherein the processor is further configured to:
generate at least one settlement statement by using the distributed ledger, the at least one settlement statement including information that relates to the plurality of billing requests;
generate at least one report by using the distributed ledger, the at least one report including information that relates to at least one billing request with an outstanding balance; and
transmit, via the application programming interface, the at least one settlement statement and the at least one report to the at least one biller based on a predetermined preference.

17. The computing device of claim 11, wherein the statement of charges includes at least one from among a first amount of money owed for goods supplied and a second amount of money owed for services rendered.

18. The computing device of claim 11, wherein, to update the distributed ledger, the processor is further configured to:
generate a new ledger entry;
determine, via each of the at least one node, whether the new ledger entry accurately represent the requested update by using a consensus algorithm; and
update each of the at least one node with the new ledger entry based on a result of the determining.

19. The computing device of claim 11, wherein the processor is further configured to:
receive, via the graphical user interface, at least one display request from the first user, the at least one display request relating to an instruction to display at least one outstanding statement of charges;
extract the user account identifier from the at least one display request;
identify the at least one outstanding statement of charges from the distributed ledger by using the extracted user account identifier; and
compile, via the at least one node, information that relates to the identified at least one outstanding statement of charges from the distributed ledger.

20. The computing device of claim 19, wherein the processor is further configured to:
generate at least one selectable graphical element, the selectable graphical element including the compiled information; and
display, via the graphical user interface, the at least one selectable graphical element in response to the at least one display request.
